(19) United States
(12) Patent Application Publication
(10) Pub. No.: US 2015/0115589 A1
(43) Pub. Date: Apr. 30, 2015

(54) MOBILE FLUID STORAGE TANK

(71) Applicant: Lonny Thiessen, Hythe (CA)

(72) Inventor: Lonny Thiessen, Hythe (CA)

(21) Appl. No.: 14/527,670

(22) Filed: Oct. 29, 2014

Related U.S. Application Data
(60) Provisional application No. 61/897,066, filed on Oct. 29, 2013.

(51) Int. Cl. B60P 3/22; B65D 6/00

(52) U.S. Cl. CPC B60P 3/2295; B65D 7/12
USPC 280/837; 137/558; 220/660; 29/428; 122/18.3

(57) ABSTRACT

A mobile fluid storage tank for the use and storage of fluids comprising a unibody construction.

### FIELD OF THE INVENTION

The present invention relates to a mobile fluid storage tank for the use and storage of fluids.

### BACKGROUND OF THE INVENTION

The oil and gas industry requires and produces large volumes of fluids. For example, multiple millions of cubic meters of fresh water are consumed every year. This clean water is used directly in exploration, formation, modification/pre-production prep (well completion) as well as in ongoing formation maintenance of the oil, gas or coalbed methane production—IE: Fracing. On the other hand, the same industry also produces millions of cubic meters of water that is contaminated and requires storage, costly treatment and disposal.

Other worksites may also have need of a large capacity storage tank, either for delivering required chemicals, water of other fluids to the worksite or for receiving and removing liquid waste product. Accordingly, mobile storage tanks have been developed, such as those taught in U.S. Pat. No. 8,226,124 (Anderson), U.S. Pat. No. 5,653,469 (Wade), and Canadian Patent Application No. 2762244 (Hamm).

However, these mobile tanks are limited in size. A mobile tank having a greater volume capacity would be useful.

Objects of the invention will be apparent from the description that follows.

### SUMMARY OF THE INVENTION

The invention consists of a mobile storage tank having a unibody construction.

In a preferred embodiment, the invention comprises a mobile fluid storage tank comprising an enclosure having a bottom, front and rear walls, a pair of opposed side walls and a top; and a plurality of vertical structural elements extending from said bottom to said top, spaced about the periphery of said bottom in abutment with and connected to said front, rear, and side walls.

In another aspect, the mobile fluid storage tank further comprises a plurality of horizontal structural elements connected to and mounted between adjacent vertical structural elements. The horizontal structural elements are connected to respective ones of said front, rear, and side walls.

In another aspect, the vertical structural elements and said horizontal structural elements being located within the enclosure.

Other aspects of the invention may include the following:
The vertical structural elements decrease in size as they extend from said bottom to said top.
Respective ones of said horizontal structural elements decrease in size from the bottom to the top.
The bottom has a front portion, a mid portion and a rear portion, said front and rear portions being elevated relative to said mid portion.
A wheel chassis connected to the rear portion, the wheel chassis movable from a retracted position wherein the mid portion being in contact with a ground surface and an extended position wherein wheels of the wheel chassis being in contact with the ground surface and elevating the mid portion off the ground surface.
A heating system located within said enclosure.
A temperature and level monitoring system.
A pair of level switches, a high level switch and a low level switch.
The heating system and the temperature and level monitoring system being connected to a control system, the control system being adapted for automatic or manual operation.
The control system connectable to the internet for remote operation and monitoring.
An onboard power supply.

In another embodiment the invention comprises a mobile fluid storage tank comprising an enclosure having a bottom, front and rear walls, a pair of opposed side walls and a top, the enclosure having a volume between 180 to 250 cubic meters, wherein the bottom having a front portion, a mid portion and a rear portion, the front and rear portions being elevated relative to the mid portion. Amd the front portion being removably connectable to a vehicle; and a wheel chassis connected to the rear portion, the wheel chassis movable from a retracted position wherein the mid portion being in contact with a ground surface and an extended position wherein wheels of the wheel chassis being in contact with the ground surface and elevating the mid portion off the ground surface.

In another embodiment, the invention comprises a method of manufacturing a mobile fluid storage tank comprising an enclosure having a front portion connectable to a vehicle and a rear portion having a plurality of wheels, the method comprising maximizing the length and width and height of the enclosure while ensuring the empty weight of the fluid storage tank meets legal axle weight constraints.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is a perspective view of a mobile storage tank according to the invention shown connected to a truck.

FIG. 1A is a perspective view of an alternative embodiment of a mobile storage tank connected to a truck.

FIG. 2 is a front view of the mobile storage tank shown in FIG. 1 shown without the truck.

FIG. 3 is a side view of the mobile storage tank shown in FIG. 2 shown in stationary mode.

FIG. 4 is a side view of the mobile storage tank shown in FIG. 3 shown in travel mode.

FIG. 5 is a perspective view of the trailer of FIG. 4 from the bottom rear.

FIG. 5A is a perspective view of the trailer of FIG. 5 with the bottom installed.

FIG. 6 is a perspective view of the bottom portion of the unibody frame of the mobile storage tank of the invention.

FIG. 7 is a perspective view of the bottom portion the unibody frame of FIG. 6 with the bottom tank surface in place.

FIG. 8 is a perspective view of the mobile storage tank showing the exterior framing connected to the bottom portion of the unibody frame shown in FIG. 7.

FIG. 9 is a top view of the partially constructed mobile storage tank shown in FIG. 8.

FIG. 10 is a side view of FIG. 9.

FIG. 11 is a perspective view of the rear wheel lift system.

FIG. 12 is a perspective view of the front lift system.

FIG. 12A is a perspective view of an alternative embodiment of a front lift system.

FIG. 13 is a perspective view of a mobile storage tank having an alternative sump arrangment.

FIG. 13A is an enlarged fragmentary view of the portion identified as A in FIG. 13.

FIG. 14 is a front view of the mobile storage tank shown in FIG. 13.

FIG. 15 is a top perspective view of the mobile storage tank of FIG. 13, with the top removed so as to show the interior.

FIG. 15A is an enlarged fragmentary view of the portion identified as A in FIG. 15.

FIG. 16 is a top view of a pair of mobile storage tanks shown interconnected.

FIG. 17 is a front view of a trio of mobile storage tanks shown interconnected.

FIG. 18 is a perspective view of four mobile storage tanks shown interconnected.

### DESCRIPTION OF THE PREFERRED EMBODIMENTS

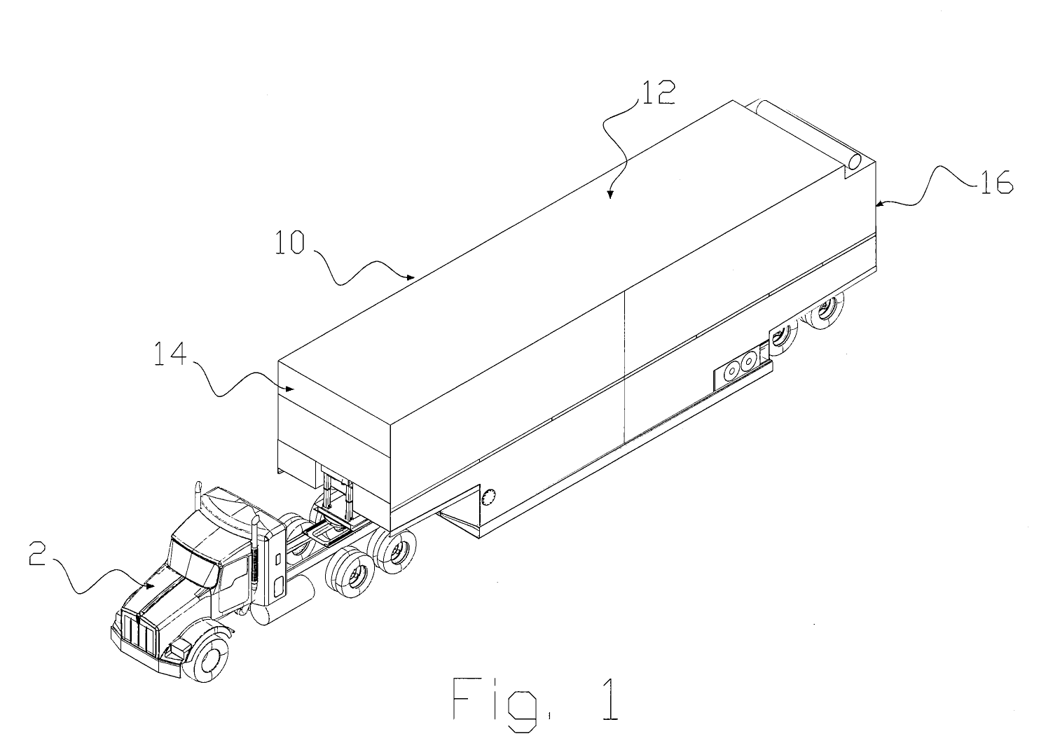

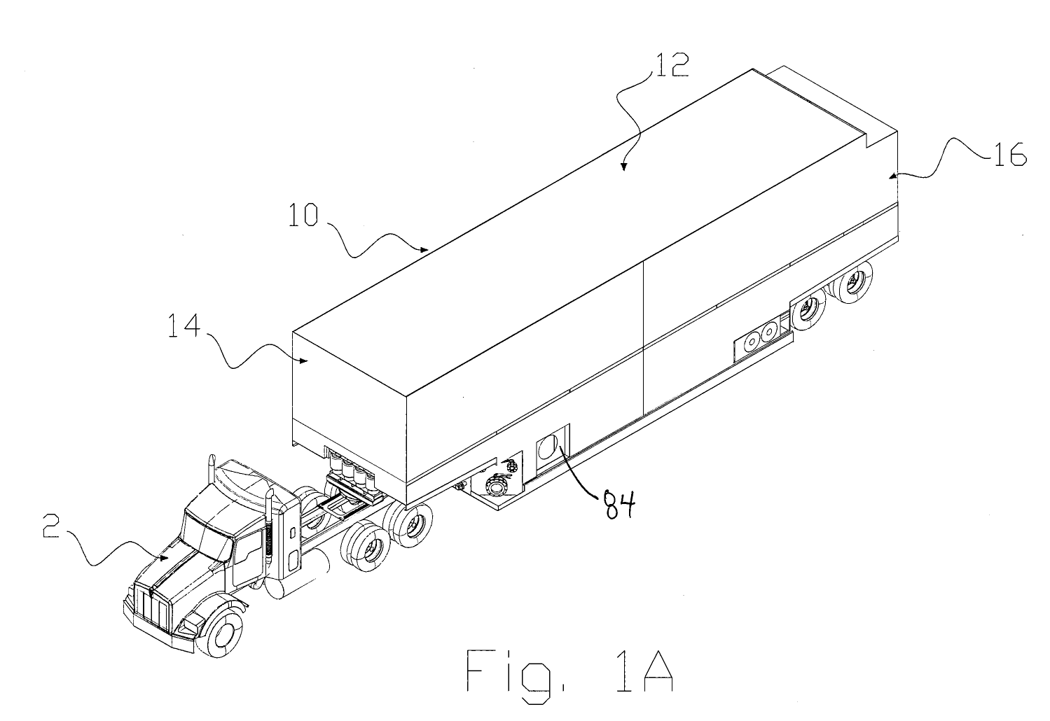

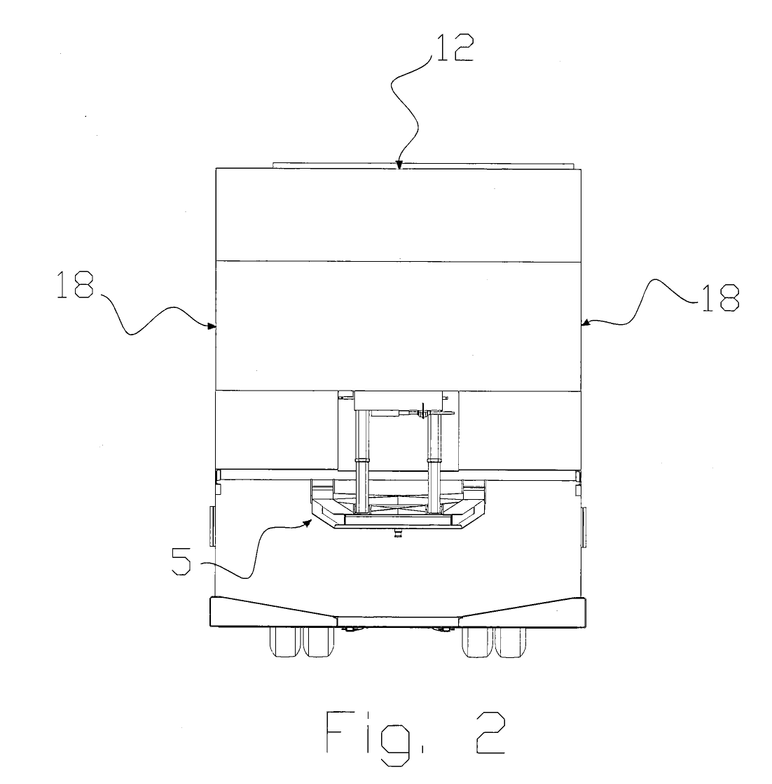

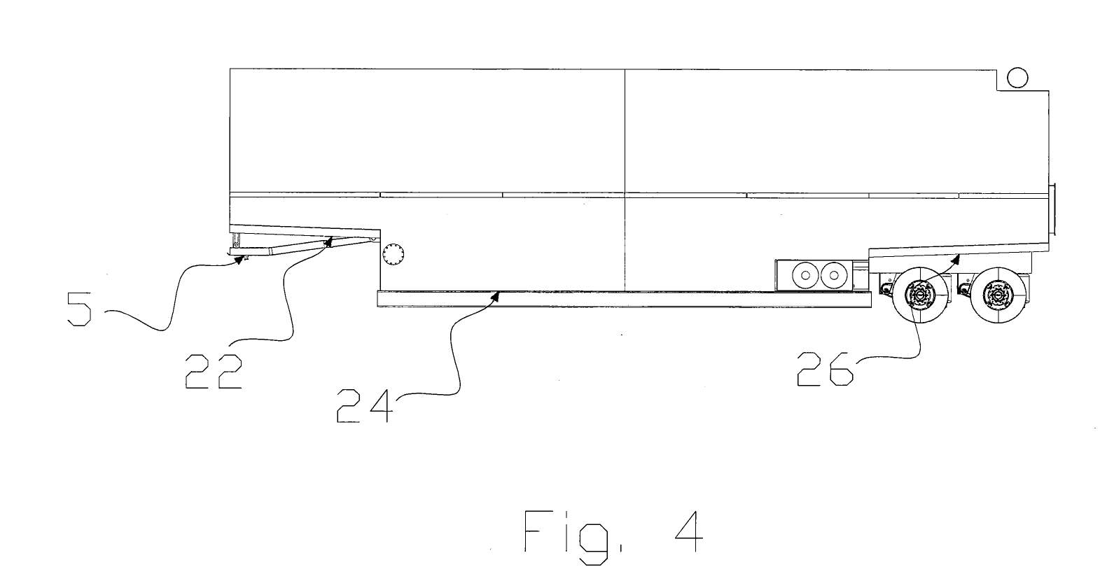

The preferred embodiment of a mobile storage tank assembly 10 according to the present invention is shown in FIG. 1 connected to a truck 2 and is shown in FIGS. 2-5 on its own, with the truck 2 disconnected from the hitching device 5. An alternative embodiment is shown in FIG. 1A.

Storage tank 10 has a top surface 12, a front wall 14, a rear wall 16, a pair of side walls 18 and a bottom 20 forming an enclosure within which liquids can be stored and transported. The bottom 20 has a front portion 22, a mid portion 24 and a rear portion 26, the front and rear portions 22, 26 being elevated above the level of the mid portion 24.

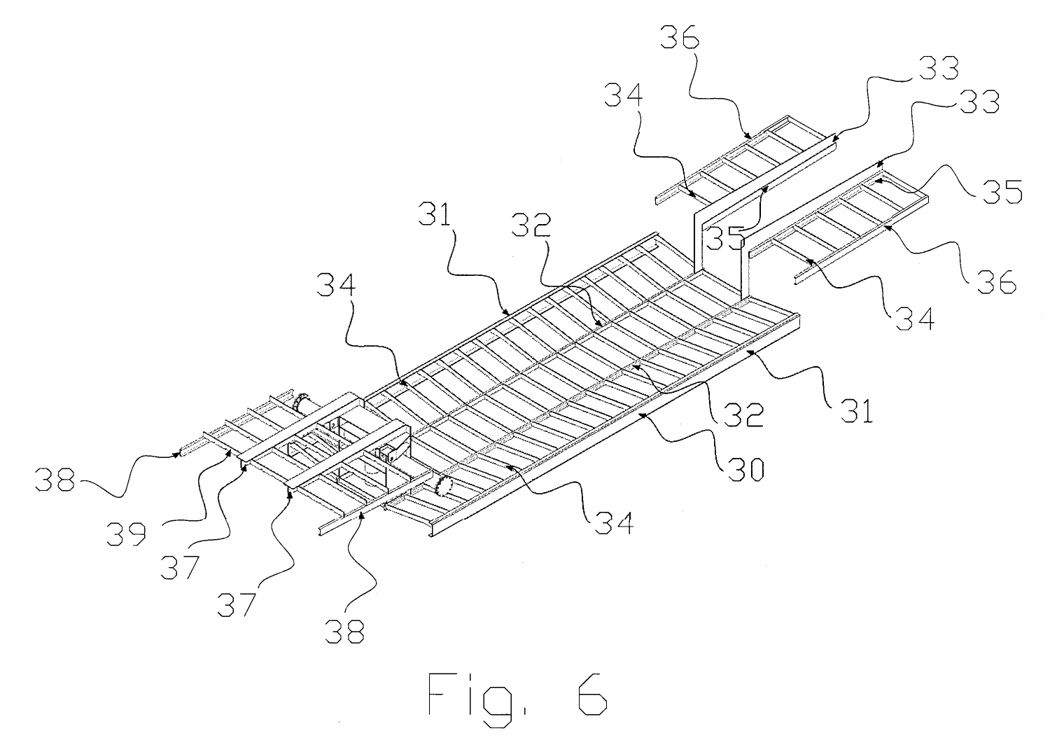

Construction of the mobile storage tank 10 will be described in more detail with reference to FIGS. 6-8. Typically mobile water tanks are designed to be round with a front to back frame in order to minimize bending and to provide longitudinal structural strength. However, in a mobile design this severely limits the volume available and increases the empty weight (tare weight) of the vessel. The present invention is designed to travel empty for on-site fluid storage. It is not adapted to travel via roadways when filled with fluid. By limiting the mobile storage tank to travel when empty, the inventors were able to maximize the volume—it is able to hold between 210-250 M3 of fluid (when parked). Mobile storage tank 10 is built using a unibody/monocoque design to form a fully structural square/rectangular tank maximizing the available volume, allowing the largest possible volume capacity within legal axle weight constraints, and providing the structural strength to withstand the stress when the tank is filled on site, often with high specific gravity liquids.

Referring to FIG. 6, the base 30 of the tank 10 is formed by a pair of opposed longitudinally extending outer I-beams 31 and a pair of opposed longitudinally extending inner I-beams 32. A plurality of cross-beams 34 are welded to the I-beams 32, 34 in order to keep them in spaced separation from one another and to provide the required structural rigidity and strength. The outer I-beams 31 are greater in height than the inner I-beams 32. The cross-beams connecting inner I-beams 32 to the outer I-beams 31 extend upwardly at a shallow angle such that the floor of the tank slopes towards the centre portion between the two inner I-beams 32. The dimensions of the inner and outer I-beams 32, 31, and the sloping connection is such that the bottoms of the respective I-beams are all at the same level such that the tank has a flat bottom as discussed more below.

The front portion 22 and rear portion 26 are formed by cantilevered beams which are angled such that front portion 22 slopes slightly downward from front to back and rear portion 26 slopes slightly downward from back to front. A pair of L-shaped beams 33 are fixedly connected by welding to the rear end of the inner I-beams 32. Rear I-beams 35 are welded to each of the L-shaped beams 33 in order to provide added strength to support the undercarriage.

Cross beams 34 connect Rear I-beams 35 to outer rear I-beams 36. A similar set up is used at the front, where front L-shaped beams 37 are fixedly connected by welding to the front end of the inner I-beams 32. Preferably, the front cantilevered L-shaped beams 37 are more substantial than the rear L-shaped I-beams 33 as it holds the drive mechanism (truck 2). In addition, in order to provide space for the hitching device 5, the front portion cross-beams 30 connect to the L-shaped-beams 37 and the top of the front outer I-beams 38, the outer I-beams 38 extending further than the L-shaped beams 37.

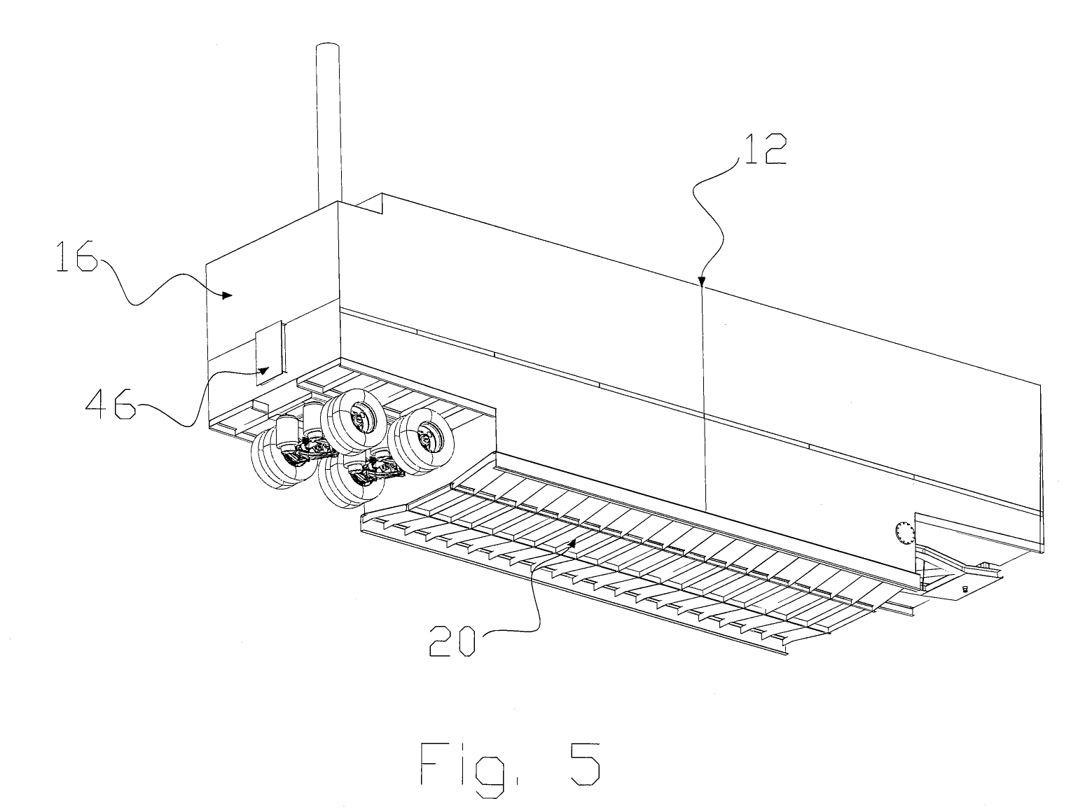

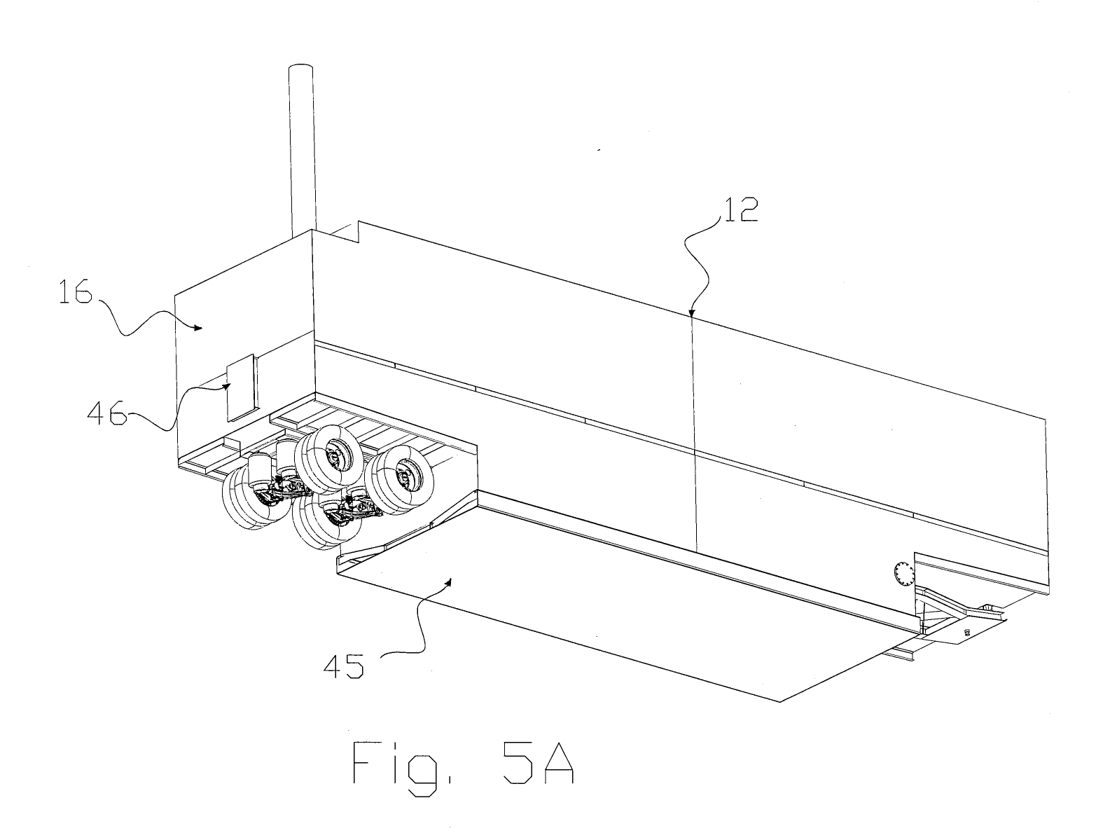

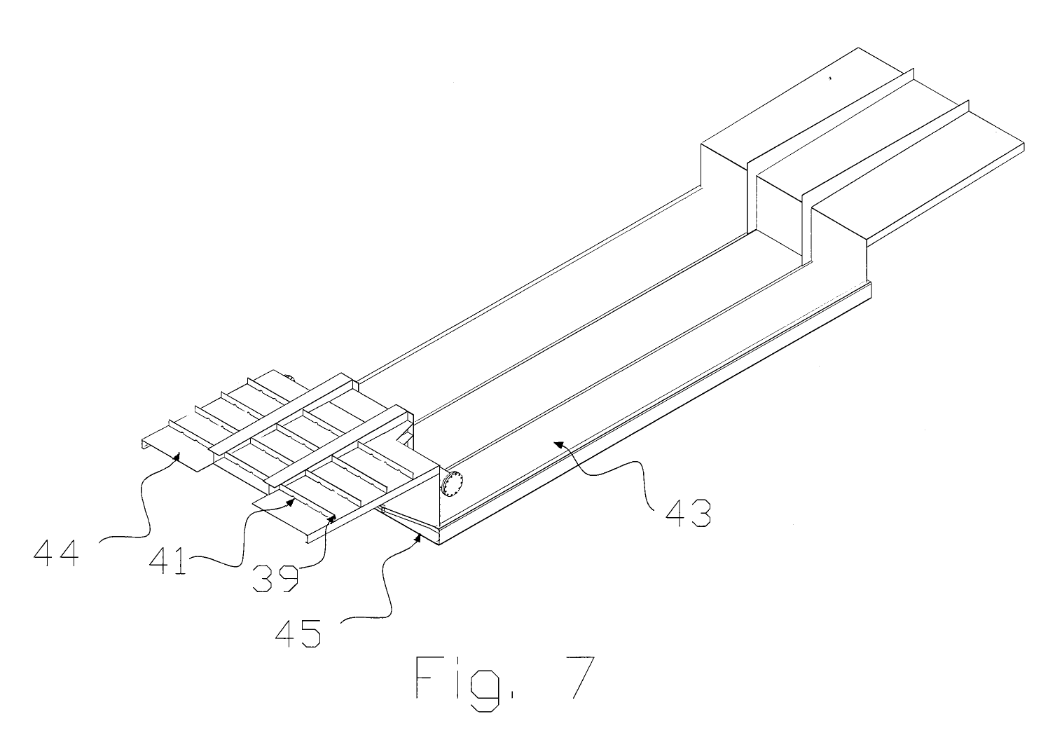

As shown in FIG. 7, steel paneling 43 is welded to the various I-beams and cross beams in order to form the bottom 20 of the tank enclosure. For the front portion 22, the floor panel 44 is hung off of the front L-shaped beams 37 with stitch welds and greater strength can be added to the system without any appreciable volume penalty. The outer cross beams 39 therefore make a connection for the floor and wall joint with a simple seal weld and do not add much to structural strength. The monocaulk design makes these outer beams less important to the system and subsequently they can be very small and light. In addition, as shown in FIG. 5A, a panel 45 is welded to the bottom of the various I-beams to form a flat bottom surface (ground contact surface) providing a sealed, flat surface for the tank to rest on. Preferably the panels are stitch welded in order to minimize distortion and to be better equipped to take bending shear and tension. Front cross-beams 39 are preferably equipped with a plurality of gaps 41 providing openings through which liquid may flow along suspended paneling 44 towards the mid portion 24.

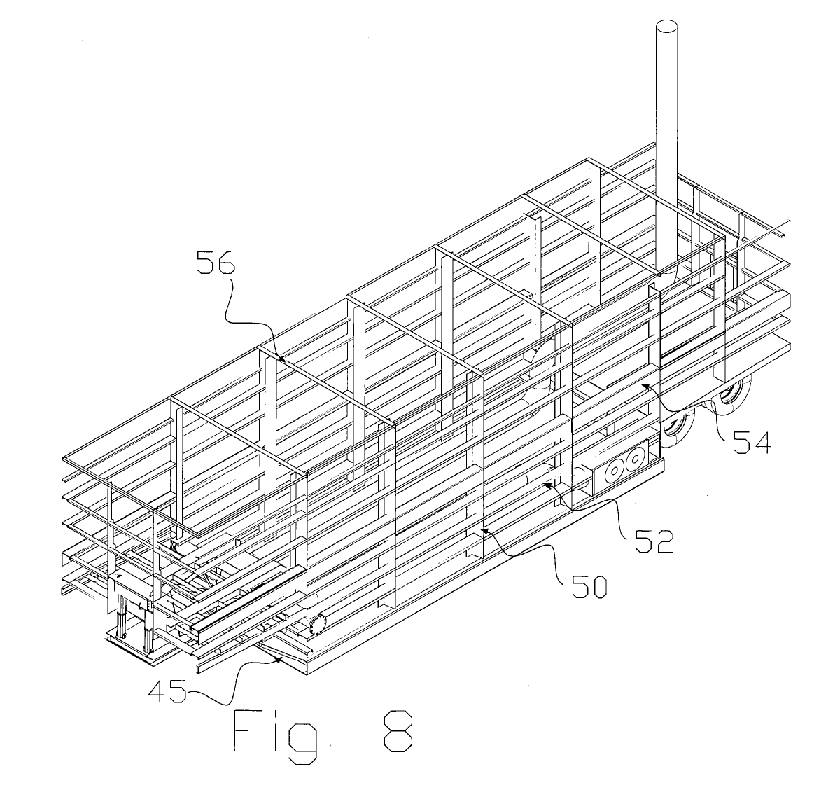

Once the floor has been installed, the remaining framing is installed, as shown in FIG. 8. Vertical beams 50 are mounted about the periphery of the base 30 and welded into place. Horizontal wall stiffeners 52 are mounted between adjacent vertical beams 50 and welded into place. Larger horizontal cross-braces 54 are also mounted between adjacent vertical beams 50 and welded in place. Preferably, the horizontal wall stiffeners 52 are formed of flat sheet stock allowing a variable cross section with height. Essentially, the size of the wall stiffeners reduces as they are placed higher along the walls. This allows the weight of the structure to be reduced at the top of the tank where the pressures are low and concentrated at the bottom where static fluid pressures are highest. This can also be done with the cross beam structural supports as shown in the drawings.

Once the framing has been installed along with any other internal components (discussed elsewhere in this application), the walls and roof are installed. For both the flooring and the walls, it is contemplated that either pre-cut full-size panels could be used or a plurality of smaller sized panels could be used.

The main cantilever structure for the wheel and tractor cut outs can be raised above the floor and similar to the wall supports (vertical beams 50, horizontal wall stiffeners 52, horizontal cross-braces 54) can be located within the tank enclosure (ie. within the fluid).

As an added benefit, the unibody design of the present invention provides the maximum base surface area when the floor 45 of the tank is resting on the ground providing very low ground pressure on soft sites when the tank is full and at max weight. This feature avoids, in most cases, the need for expensive matting to be used and the installation of that matting (cranes and additional trucks and labor are involved for the installation of matting) under the tanks which is very common and required in the industry.

The unibody design with an integral outer skin allows the external walls of the tank to be flat and smooth with all the structural elements located internally, formed in small sections, and held to the wall with stitch welds holding the shear of the wall bending plane and tension as the wall membrane pulls away from the structure. This affords a lighter and simpler design that can be more easily manufactured, has better strength characteristics and is easily insulated due to a smooth outer wall surface. Other designers have incorporated breaks in the wall but this does not allow a thinning wall section as the pressure reduces with height and causes a large shop fabrication handling expense as well as a very heavy structure. Thickness of panels will be chosen based on providing adequate strength at the different heights depending on the size of the tank being built.

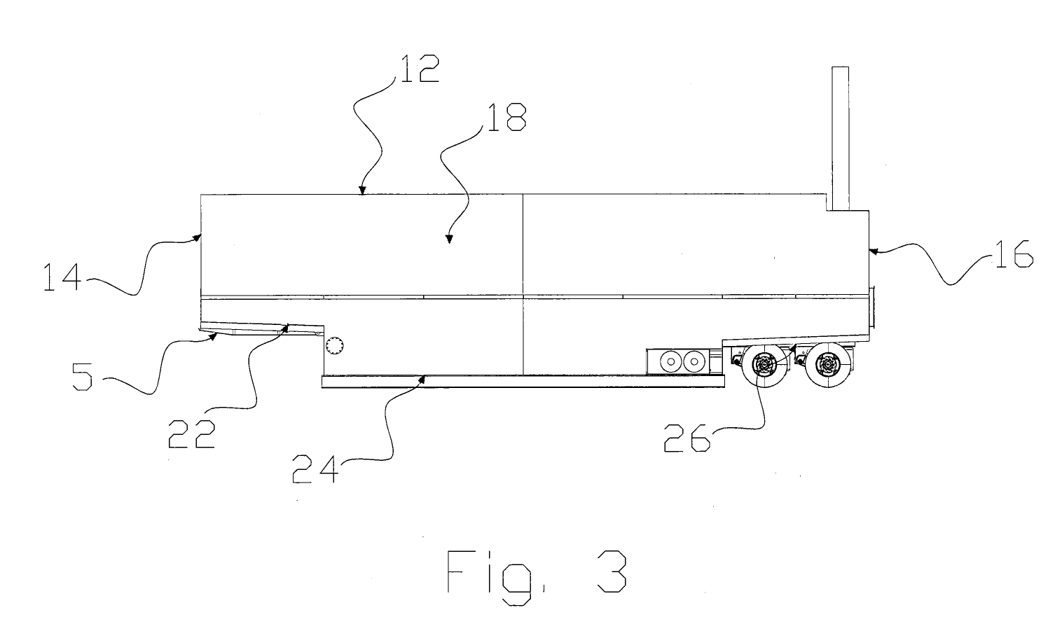

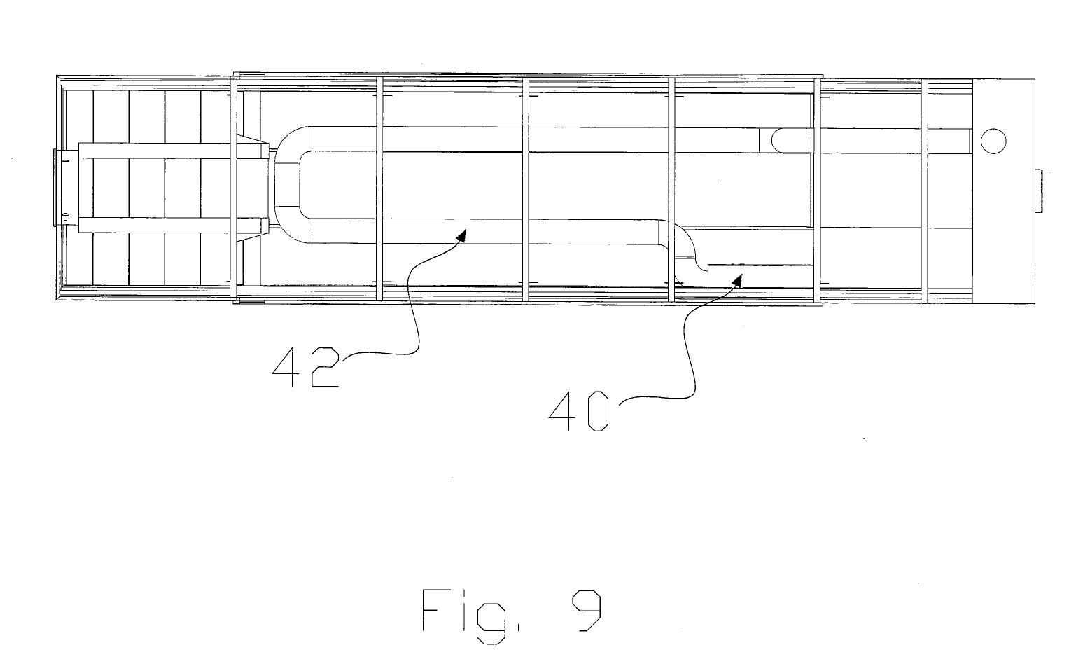

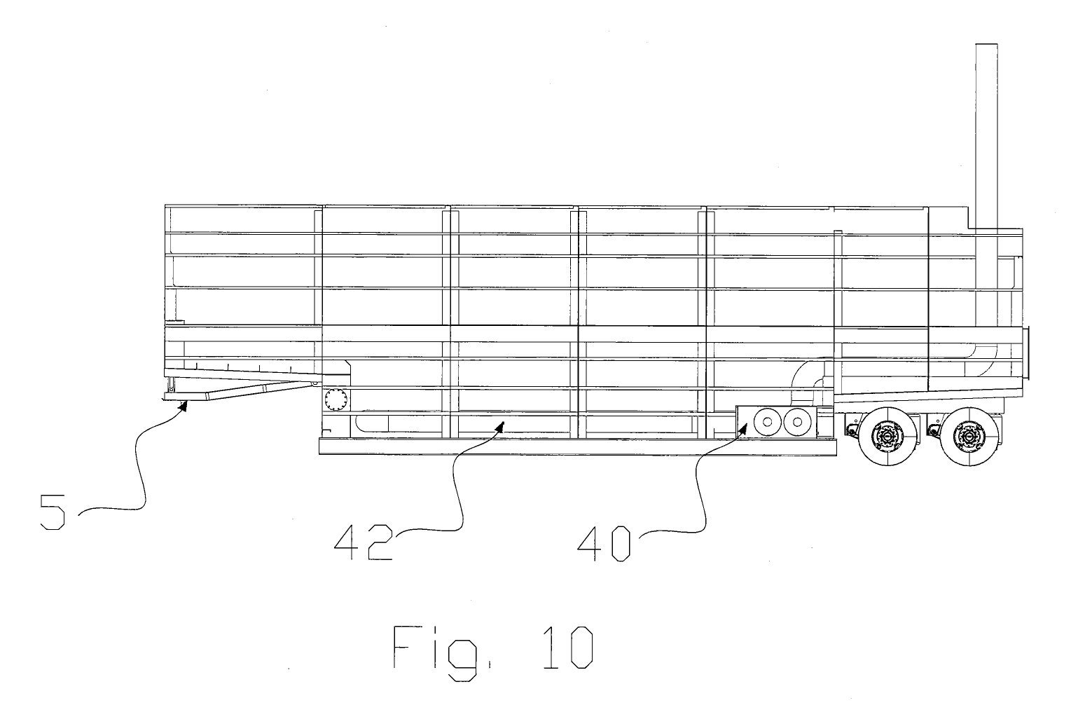

As shown in FIGS. 9 and 10, the mobile storage tank is equipped with a heating system in the form of a burner 40 connected to exhaust piping 42 which circulates along the bottom surface of the interior of tank 10 and terminates in exhaust duct 44, which is pivotable from a stored horizontal position (shown in FIG. 1) to a vertical position (shown in FIG. 3). Preferably, the burner is a 2 mmbtu natural draft burner design that is CSA B146 certified/compliant and runs on natural gas, propane or diesel. It is also contemplated that other systems, such as a CSA approved forced draft burner could be used. Preferably exhaust piping 42 is 16″ heavy wall steel pipe that is mounted 4-6 inches off of the floor in order to get heat transfer on the bottom part of the tube as well as to allow for cleaning under the tube as needed. Access to the interior of the tank enclosure is provided by two entry doors 84 installed in the outer shell of the tank—one on either side of the unit at appropriate heights and diameters to allow a man safe entry and exit. The exhaust piping 42 will be routed in such a way so as to provide the best heat transfer and mixing characteristics for a given tank. Heat is transferred via air-to-metal via non-intrusive contact and thereby to the liquids in the tank. The heat is dispersed through the liquid by way of natural convection, with the hot fluid rising up in the tank while colder fluid circulates to the bottom of the tank. Preferably the tank is insulated by applying insulated sheeting covered with a metal surface and then painted; for example 2-3 inch thick insulated sheeting is secured in place with insulation fixtures that are tack welded to the outer shell. This system covers the sides and front and back. The roof and underside have spray-foam insulation applied after the electrical devices and cabling are installed.

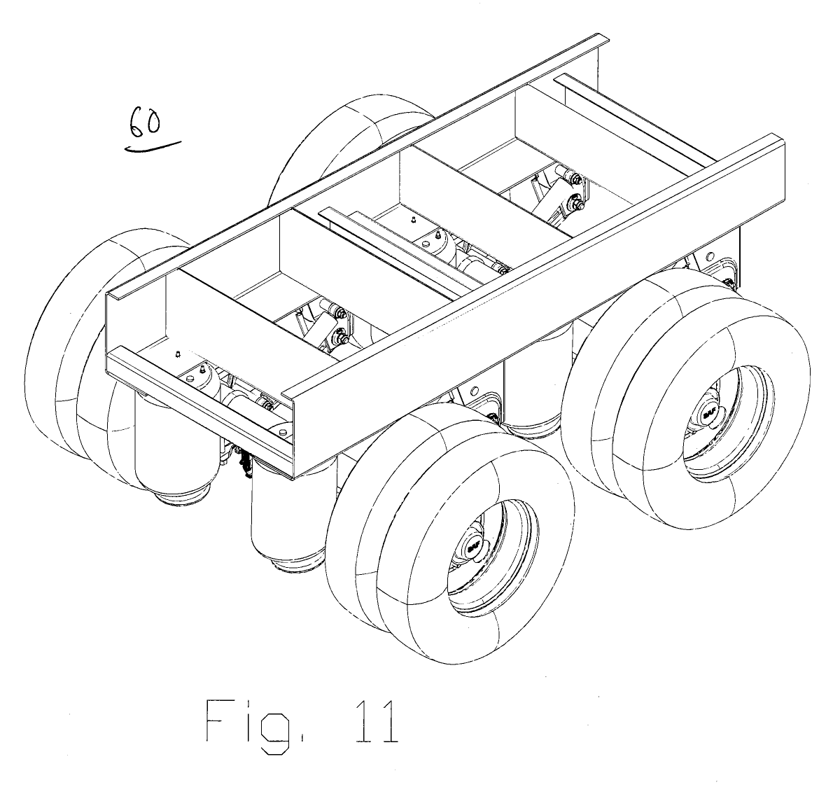

The rear lift system 60 is shown in FIG. 11. Preferably it takes the form of an air ride/air lift suspension system such as that manufactured by Silent Drive Inc. that is welded to the rear I-beams 35. The rear lift system is adapted to extend the wheels into position for travel (thereby supporting the mobile storage tank in an elevated position relative to the ground) and to allow them to retract when the mobile storage tank is lowered onto the ground to be filled with fluid.

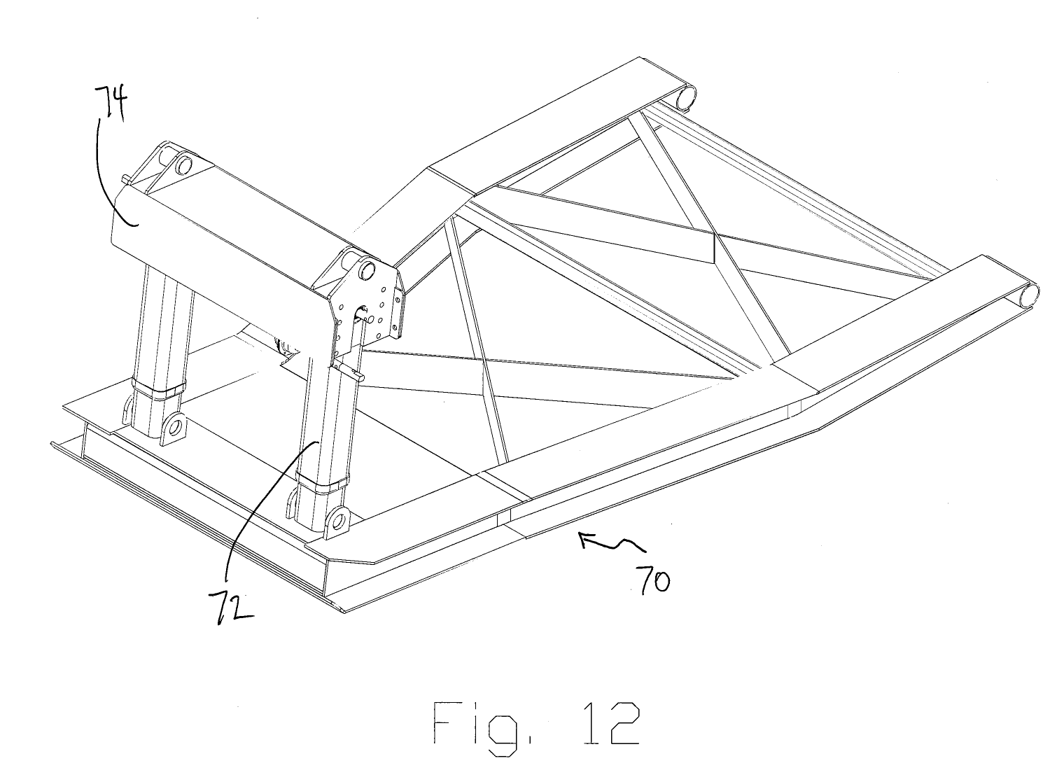

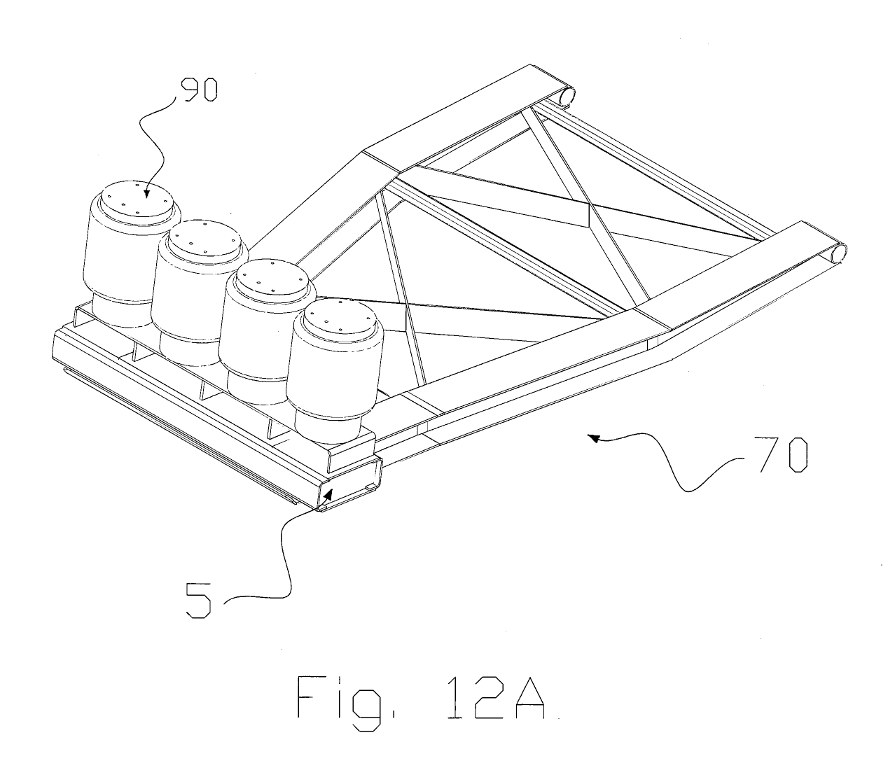

The front lift system 70 is shown in FIG. 12. The front lifting system 70 lifts the weight of the mobile tank 10 up into road position by forcing the hitch plate 5 downward after the tank is hooked to the truck 2. The lift is provided by telescoping screw jacks 72. This is different from the normal system that would see the jacking system exerting force between the trailer and the ground and raising the trailer to pin-up height before the tractor can back under. The present system allows the truck 2 to back under first, pin-up and then extend the telescoping legs downward increasing the distance between the top anchor point on the front of the tank body and the hitch plate that is now connected to the truck. This system avoids numerous issues such as the common problem of trying to lift the weight of the tank in soft ground where the legs must be matted or blocked in order to avoid them sinking into the ground and not lifting the tank high enough to pin onto the truck. The front lifting system 70 frame also incorporates a very strong framework and a wide stance, offering greater stability of the load as it is being towed down the road as compared to other similar systems.

An alternative front lift system is shown in FIG. 12A. Rather than using telescoping screw jacks, the alternative embodiment makes use of a plurality of air pumps 90 to exert the required force to lift the mobile storage tank 10 into position for moving. The air pumps may rely on air from the truck 2 brake system or alternatively, the tank 10 may have its own compressed air source.

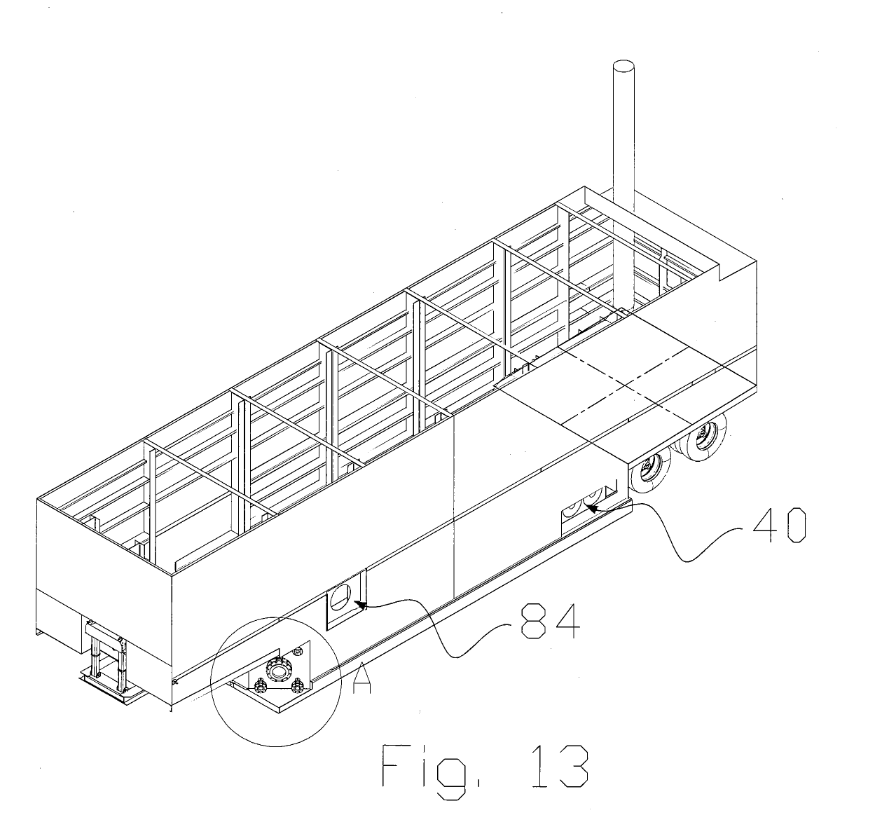

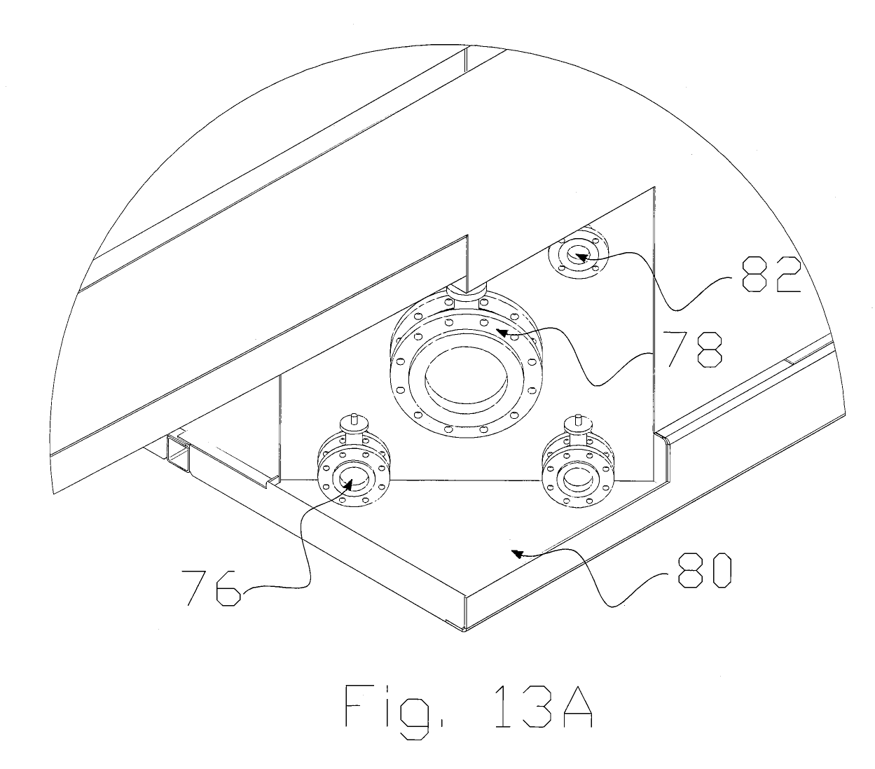

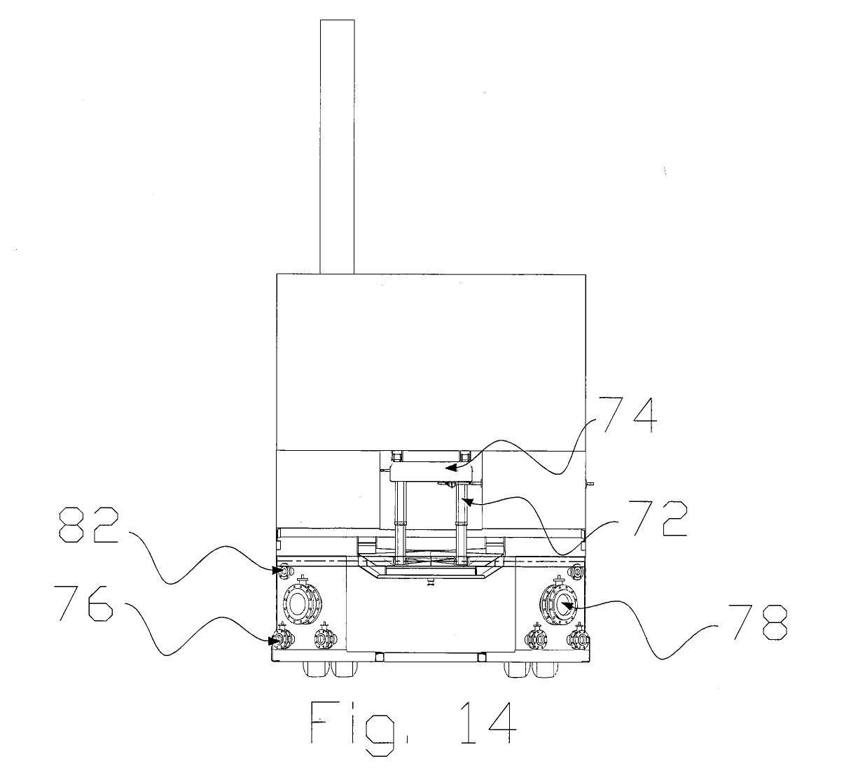

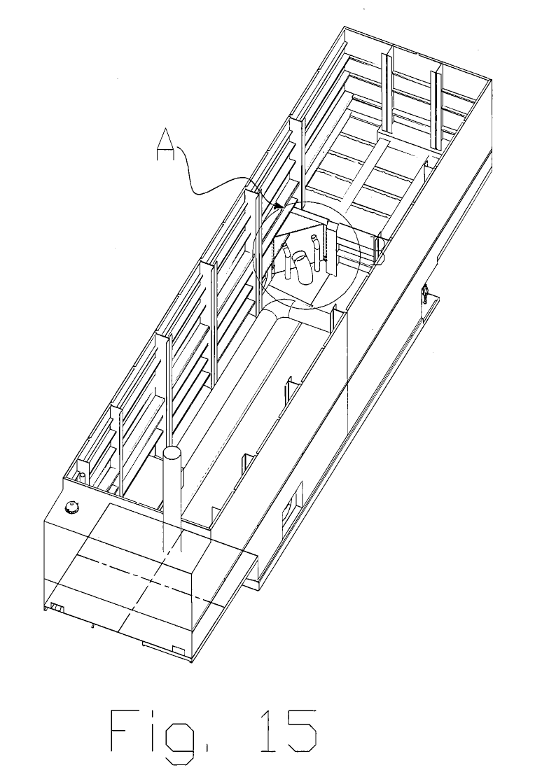

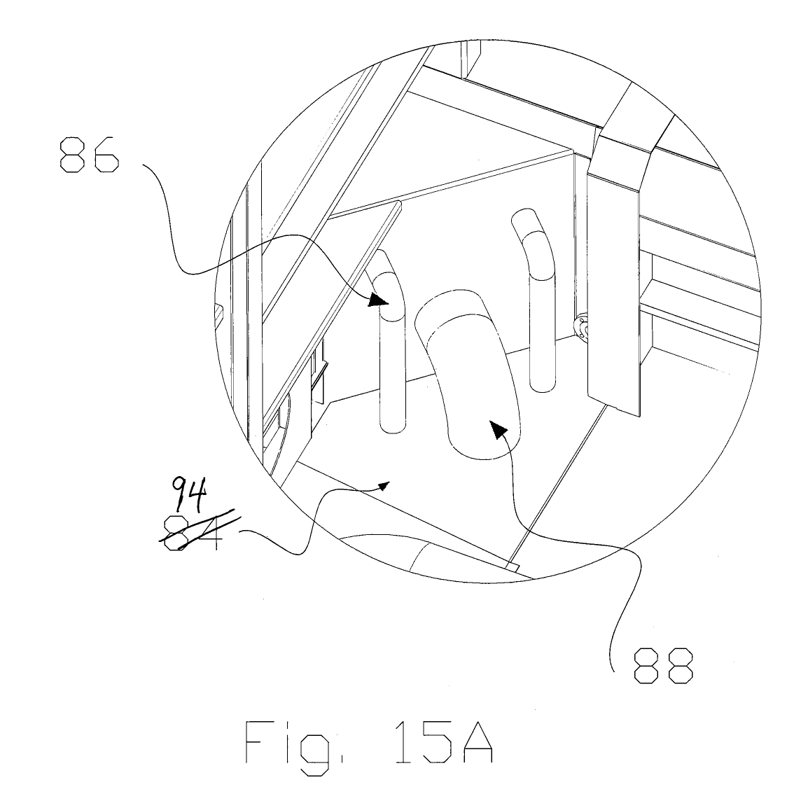

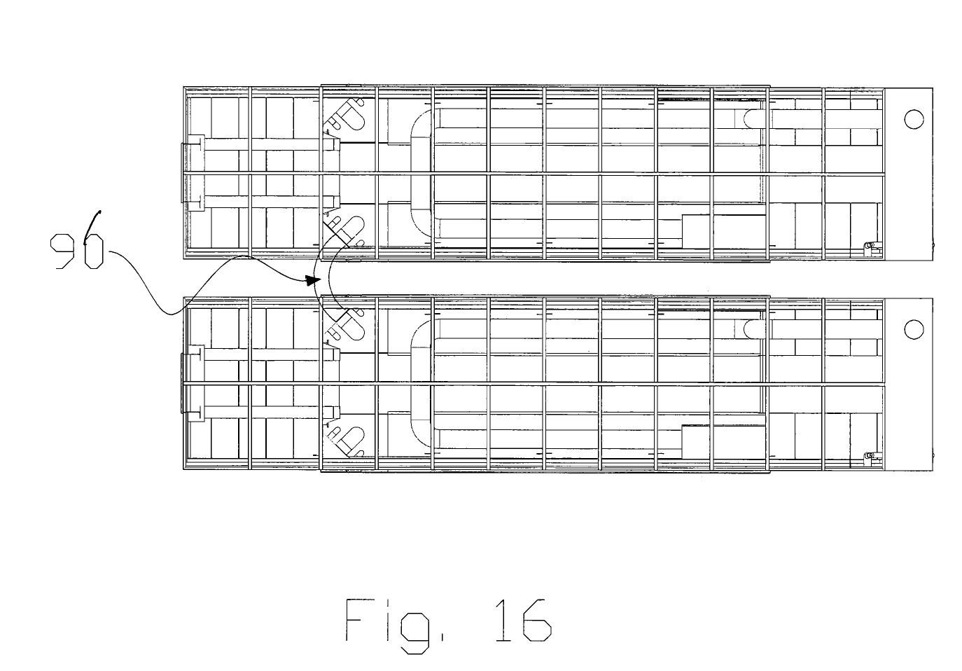

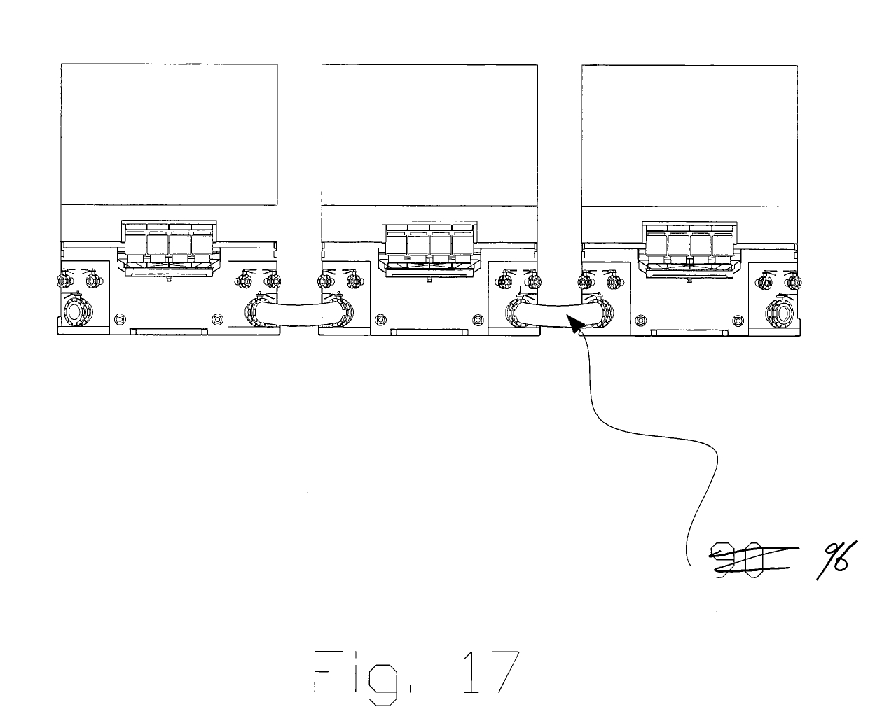

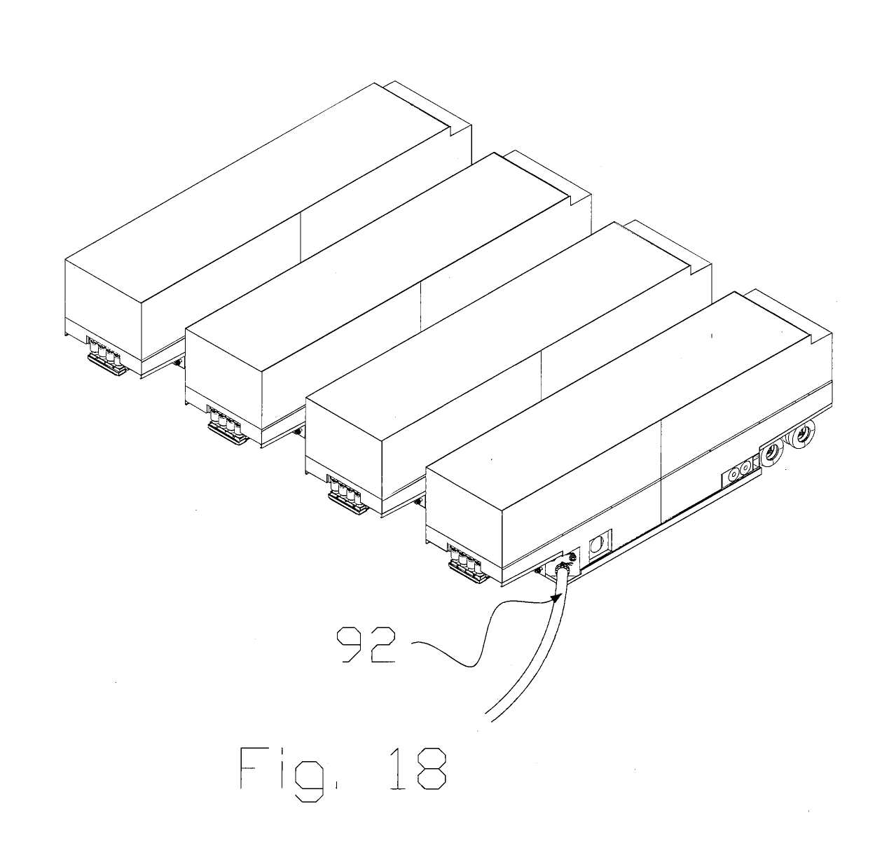

An alternative sump pump arrangement is shown in FIGS. 13-18. Preferably, the sump panel comprises a pair of smaller 4 inch valve hookups 76 and a large 10-14 inch main tank hookup 78. The smaller valves 76 are alternates to the large hookup and may be required with some oilfield equipment which only have the smaller fittings. The main tank hookup 78 may be used for interconnections between adjacent mobile storage tanks 10, as shown in FIGS. 16-18 and for connection to end use manifolds such as conduit 92 in FIG. 18. A drip tray 80 catches any spillage during connection or disconnection. It may also comprise at least one steam line hook up 82. Steam lines may be required as a back-up to the onboard heating system.

In this alternative arrangement, the sumps drain into the new outlet configuration shown. The internal manifold system has been removed in favor of an external manifold that is designed for ease of connection coming out of the tank at a very low level. In addition, the new pump system is mounted at a 45 deg angle outward and a slight angle downward and can be accessed from the outside of the tank (in case of freezing). The sump area is directly behind the connection face and is provided by a sunken area approximately 3′ square and about 4-6 inches below the level of the main tank bottom. The main tank 78 pipe and the two 4 inch connections 76 have 90 deg downspouts on the inside of the tank that reach down into the sump area to ensure complete drainage and clean-out.

The tank 10 is preferably equipped with at least one temperature and level transmitter (not shown), such as the single channel tank fluid monitor manufactured by Garnet Instruments Ltd., which measures both level and temperature and sends the information to a panel display. The level transmitter is used as a measurement device for level and interface measurement in liquids, including viscous liquids. The monitor is suitable for the wide range of temperatures that it will be subjected to. Preferably, the Garnet level/temp probe will be located in the centre of the tank enclosure—installed and accessed from the top/roof and extending downward to the bottom of the tank landing at the floor at a point equidistant between the two looping fire-tubes (exhaust piping 42). It will also be anchored to the floor to prevent movement and damage when in transport mode.

The tank may also be equipped with a motion activated video system for security and loading unloading accountability. It may also be equipped with monitoring equipment for measuring pH, total dissolved solids (TDS), or other chemical characteristics of any fluid stored within the tank. GPS location information and movement information could also be monitored and linked to a central monitoring station.

The temperature measurements will be used to control internal fluid temperatures and other tank systems and will work in conjunction with the heating system either through manual control or through a programmable logic system according to pre-set parameters. The tank 10 is designed to incorporate the latest generation of ‘Smart Machines’ that are connected to the internet. All tanks will be connected to the cloud/internet and will have the ability to be monitored via the web or a smart-phone and or controlled through web-based control type software via a web browser or smart-phone. The tanks will connect from their remote locations via cellular or satellite links.

The tank 10 is also preferably equipped with at least two level switches, a high level switch and a low level switch. Preferably these are discrete level switches providing an on/off function.

Typically, these would be a float-type switch with the fluid level pushing the float up as the fluid level goes up. The low level switch would be used as an interlock to the operation of the heating system. For example, if the fluid level is too low, the heating system will be deactivated in order to avoid any overheating. The high level switch would provide an indication that the max tank fill level had been reached thereby alerting site personnel to cease transfer of fluids so as to avoid the spilling of costly process fluids such as fracing solution, produced water and the like and the environmental concerns with same.

The various systems found in the tank 10 will be controlled with automation equipment. The system must preferably accomplish at least some of the following:
1. Monitor and display the 0-100% fluid level in the tank;
2. Monitor and display the tank temperature measurements;
3. Start/stop and monitor the status of the heater system based on the tank temperature and fluid level;
4. GPS tracked location and movement;
5. Connect to the internet for monitoring or full SCADA control via cellular or satellite links;
6. May have security features included in the intelligence package such as motion sensing cameras that start taking photos when motion is detected or when the level in the tank starts to drop—suggesting a leak or someone stealing fluid; and
7. May have other smart monitoring instruments and features added as needed.

The control system 46 (see FIG. 5) is mounted on the back of the tank in an all weather/explosion-proof cabinet. Preferably, each tank is equipped with an onboard power supply such as an onboard generator set or a methanol fuel cell, solar panel, batteries or other power source. The generator info will also be sent to the cloud for monitoring or control; for example, the control system would monitor kws being used, level in fuel tank, critical parameters of the generator etc. If the tanks are deployed individually where the heating system is not required it may be equipped with a much smaller onboard generator or other such power source as the electrical demands will be reduced. When working in an application that requires a group of tanks, such as shown in FIGS. 16-18, a separate generator may also be provided if necessary.

It will be appreciated by those skilled in the art that the preferred and alternative embodiments have been described in some detail but that certain modifications may be practiced without departing from the principles of the invention.

What is claimed is:

1. A mobile fluid storage tank comprising:
an enclosure having a bottom, front and rear walls, a pair of opposed side walls and a top; and
a plurality of vertical structural elements extending from said bottom to said top, spaced about the periphery of said bottom in abutment with and connected to said front, rear, and side walls.

2. The mobile fluid storage tank of claim 1 further comprising a plurality of horizontal structural elements connected to and mounted between adjacent vertical structural elements.

3. The mobile fluid storage tank of claim 2 wherein said horizontal structural elements being connected to respective ones of said front, rear, and side walls.

4. The mobile fluid storage tank of claim 3 wherein said vertical structural elements and said horizontal structural elements being located within said enclosure.

5. The mobile fluid storage tank of claim 1 wherein said vertical structural elements decrease in size as they extend from said bottom to said top.

6. The mobile fluid storage tank of claim 3 wherein respective ones of said horizontal structural elements decrease in size from said bottom to said top.

7. The mobile fluid storage tank of claim 3 wherein said bottom having a front portion, a mid portion and a rear portion, said front and rear portions being elevated relative to said mid portion.

8. The mobile fluid storage tank of claim 7 further comprising a wheel chassis connected to said rear portion, said wheel chassis movable from a retracted position wherein said mid portion being in contact with a ground surface and an extended position wherein wheels of said wheel chassis being in contact with said ground surface and elevating said mid portion off said ground surface.

9. The mobile fluid storage tank of claim 1 further comprising a heating system located within said enclosure.

10. The mobile fluid storage tank of claim 9 further comprising a temperature and level monitoring system.

11. The mobile fluid storage tank of claim 10 further comprising a pair of level switches, a high level switch and a low level switch.

12. The mobile fluid storage tank of claim 10 wherein said heating system and said temperature and level monitoring system being connected to a control system, said control system being adapted for automatic or manual operation.

13. The mobile fluid storage tank of claim 11 wherein said control system connectable to the internet for remote operation and monitoring.

14. The mobile fluid storage tank of claim 12 further comprising an onboard power supply.

15. A mobile fluid storage tank comprising:
an enclosure having a bottom, front and rear walls, a pair of opposed side walls and a top, said enclosure having a volume between 180 to 250 cubic meters;
wherein said bottom having a front portion, a mid portion and a rear portion, said front and rear portions being elevated relative to said mid portion;
said front portion being removably connectable to a vehicle;
a wheel chassis connected to said rear portion, said wheel chassis movable from a retracted position wherein said mid portion being in contact with a ground surface and an extended position wherein wheels of said wheel chassis being in contact with said ground surface and elevating said mid portion off said ground surface.

16. The mobile fluid storage tank of claim 15 further comprising a plurality of vertical structural elements extending from said bottom to said top, spaced about the periphery of said bottom in abutment with and connected to said front, rear, and side walls.

17. The mobile fluid storage tank of claim 16 further comprising a plurality of horizontal structural elements connected to and mounted between adjacent vertical structural elements.

18. The mobile fluid storage tank of claim 17 wherein said horizontal structural elements being connected to respective ones of said front, rear, and side walls.

19. A method of manufacturing a mobile fluid storage tank comprising an enclosure having a front portion connectable to a vehicle and a rear portion having a plurality of wheels, said method comprising:
a. maximizing the length and width and height of said enclosure while ensuring the empty weight of the fluid storage tank meets legal axle weight constraints.
